(19) United States
(12) Patent Application Publication
(10) Pub. No.: US 2017/0055003 A1
(43) Pub. Date: Feb. 23, 2017

(54) Context Reduction Of Palette Run Type In High Efficiency Video Coding (HEVC) Screen Content Coding (SCC)

(71) Applicant: Futurewei Technologies, Inc., Plano, TX (US)

(72) Inventors: Haoping Yu, Carmel, IN (US); Wei Wang, San Jose, CA (US); Meng Xu, Santa Clara, CA (US)

(21) Appl. No.: 14/831,408

(22) Filed: Aug. 20, 2015

(51) Int. Cl. H04N 19/90; H04N 19/13

(52) U.S. Cl. CPC H04N 19/90; H04N 19/13

(57) ABSTRACT

An encoding apparatus includes a processor configured to receive a video frame including screen content and generate a block containing an index map of colors for screen content in the video frame. The block includes a first string of index values and a second string of the index values immediately below the first string. The processor is also configured to encode a second string palette_run_type flag corresponding to the second string without referencing a first string palette_run_type flag corresponding to the first string and using a single available context. A transmitter operably coupled to the processor is configured to transmit the second string palette_run_type flag in a bitstream to a decoding apparatus.

### STATEMENT REGARDING FEDERALLY SPONSORED RESEARCH OR DEVELOPMENT

Not applicable.

### REFERENCE TO A MICROFICHE APPENDIX

Not applicable.

### BACKGROUND

The amount of video data needed to depict even a relatively short film can be substantial, which may result in difficulties when the data is to be streamed or otherwise communicated across a communications network with limited bandwidth capacity. Thus, video data is generally compressed prior to being communicated across modern day telecommunications networks. Video compression devices often use software and/or hardware at the source to code the video data prior to transmission, thereby decreasing the quantity of data needed to represent digital video images. The compressed data is then received at the destination by a video decompression device that decodes the video data. With limited network resources and ever increasing demands of higher video quality, improved compression and decompression techniques that improve image quality without increasing bit-rates are desirable.

### SUMMARY

In one embodiment, the disclosure includes an encoding apparatus having a processor and a transmitter. The processor is configured to receive a video frame including screen content, generate a block containing an index map of colors for screen content in the video frame, where the block includes a first string of index values and a second string of the index values immediately below the first string, and encode a second string palette_run_type flag corresponding to the second string without referencing a first string palette_run_type flag corresponding to the first string and using a single available context. The transmitter is operably coupled to the processor and configured to transmit the second string palette_run_type flag in a bitstream to a decoding apparatus.

In another embodiment, the disclosure includes a method of encoding. The method includes receiving, by a receiver, a video frame including screen content, generating, by a processor operably coupled to the receiver, a block containing an index map of colors for screen content in the video frame, wherein the block includes a first string of index values and a second string of the index values immediately below the first string, encoding, by the processor, a second string palette_run_type flag corresponding to the second string without referencing a first string palette_run_type flag corresponding to the first string and using a single available context, and transmitting, by a transmitter operably coupled to the processor, the second string palette_run_type flag in a bitstream to a decoding apparatus.

In yet another embodiment, the disclosure includes a decoding apparatus including a receiver and a processor. The receiver is configured to receive a second palette_run_type flag in a bitstream, where the second palette_run_type flag was encoded without referencing a first string palette_run_type flag corresponding to the first string and using a single available context. The processor is operably coupled to the receiver and configured to decode the second palette_run_type flag in the bitstream using the single available context.

These and other features will be more clearly understood from the following detailed description taken in conjunction with the accompanying drawings and claims.

### BRIEF DESCRIPTION OF THE DRAWINGS

For a more complete understanding of this disclosure, reference is now made to the following brief description, taken in connection with the accompanying drawings and detailed description, wherein like reference numerals represent like parts.

FIG. 1 is a block of index map colors used to illustrate index map coding using COPY_ABOVE in the one dimensional (1-D) string method.

FIG. 2 is a flowchart of an embodiment of a method of coding using a simplified context model.

FIG. 3 is an embodiment of a video encoder.

FIG. 4 is an embodiment of a video decoder.

FIG. 5 is an embodiment of a network unit that may comprise an encoder and decoder.

FIG. 6 is a schematic diagram of a typical, general-purpose network component or computer system.

### DETAILED DESCRIPTION

It should be understood at the outset that, although an illustrative implementation of one or more embodiments are provided below, the disclosed systems and/or methods may be implemented using any number of techniques, whether currently known or in existence. The disclosure should in no way be limited to the illustrative implementations, drawings, and techniques illustrated below, including the exemplary designs and implementations illustrated and described herein, but may be modified within the scope of the appended claims along with their full scope of equivalents.

Typically, video media involves displaying a sequence of still images or frames in relatively quick succession, thereby causing a viewer to perceive motion. Each frame may comprise a plurality of picture elements or pixels, each of which may represent a single reference point in the frame. During digital processing, each pixel may be assigned an integer value (e.g., 0, 1, . . . or 255) that represents an image quality or characteristic, such as luminance or chrominance, at the corresponding reference point. In use, an image or video frame may comprise a large amount of pixels (e.g., 2,073,600 pixels in a 1920×1080 frame). Thus, it may be cumbersome and inefficient to encode and decode (referred to hereinafter simply as code) each pixel independently. To improve coding efficiency, a video frame is usually broken into a plurality of rectangular blocks or macroblocks, which may serve as basic units of processing such as prediction, transform, and quantization. For example, a typical N×N block may comprise N² pixels, where N is an integer greater than one and is often a multiple of four.

In the International Telecommunications Union (ITU) Telecommunications Standardization Sector (ITU-T) and the International Organization for Standardization (ISO)/International Electrotechnical Commission (IEC), new block concepts were introduced for High Efficiency Video Coding (HEVC). For example, coding unit (CU) may refer to a sub-partitioning of a video frame into rectangular blocks of equal or variable size. In HEVC, a CU may replace macroblock structure of previous standards. Depending on a mode of inter or intra prediction, a CU may comprise one or more prediction units (PUs), each of which may serve as a basic unit of prediction. For example, for intra prediction, an 8×8 CU may be symmetrically split into four 4×4 PUs. For another example, for an inter prediction, a 64×64 CU may be asymmetrically split into a 16×64 PU and a 48×64 PU. Similarly, a PU may comprise one or more transform units (TUs), each of which may serve as a basic unit for transform and/or quantization. For example, a 32×32 PU may be symmetrically split into four 16×16 TUs. Multiple TUs of one PU may share a same prediction mode, but may be transformed separately. Herein, the term block may generally refer to any of a macroblock, CU, PU, or TU.

Depending on the application, a block may be coded in either a lossless mode (e.g., no distortion or information loss) or a lossy mode (e.g., with distortion). In use, high quality videos (e.g., with YUV subsampling of 4:4:4) may be coded using a lossless mode, while low quality videos (e.g., with YUV subsampling of 4:2:0) may be coded using a lossy mode. As used herein, the Y component in YUV refers to the brightness of the color (the luminance or luma) while the U and V components refer to the color itself (the chroma). Sometimes, a single video frame or slice (e.g., with YUV subsampling of either 4:4:4 or 4:2:0) may employ both lossless and lossy modes to code a plurality of regions, which may be rectangular or irregular in shape. Each region may comprise a plurality of blocks. For example, a compound video may comprise a combination of different types of contents, such as text and computer graphic content (e.g., non-camera-captured images) and natural-view content (e.g., camera-captured video). In a compound frame, regions of texts and graphics may be coded in a lossless mode, while regions of natural-view content may be coded in a lossy mode. Lossless coding of texts and graphics may be desired in, for example, computer screen sharing applications, since lossy coding may lead to poor quality or fidelity of texts and graphics, which may cause eye fatigue.

With the rapid and continuous advancements made in semiconductors, networking, communications, displays, computers, and devices such as tablets and smart phones, many applications call for HEVC-based compression/coding solutions that can efficiently compress the non-camera-captured video content at high visual quality. This non-camera-captured video content, which may be referred to herein as screen content, may include computer generated graphics, text with typical motion commonly seen in applications such as window switching and moving, text scrolling, and the like. In many cases, the non-camera-captured video content provides clear textures and sharp edges with distinct colors at high contrast and may have a 4:4:4 color sampling format.

Current HEVC screen content coding introduces a palette mode to more efficiently represent computer screens. The palette mode is described in R. Joshi and J. Xu, Working Draft 2 of HEVC Screen Content Coding, MPEG-N14969/JCTVC-S1005, Strasbourg, FR, October 2014 (HEVC SCC), which is incorporated herein by this reference. The palette mode is also utilized in the Screen Content Coding Test Model (SCM) 2.0 reference software.

Despite the efficiency provided by the palette mode within the current HEVC framework, there is still room for improvement. Disclosed herein are systems and methods for improved video coding. The disclosure provides a simplified entropy (e.g., lossless) coding scheme. To reduce the overall complexity, the coding scheme encodes a flag (e.g., a palette_run_type_flag) without referring to the run_type (e.g., COPY_ABOVE) of a flag for an above index (e.g., a string above the current string). As a result, the inventive coding scheme needs only a single context. Using the new coding scheme will reduce the total number of contexts for the entire codec, and also made the encoding and decoding process simpler.

The current HEVC SCC draft utilizes a run-based one dimensional (1-D) string copy. Even so, two dimensional (2-D) string copy methods have been proposed in W. Wang, Z. Ma, M. Xu, H. Yu, “Non-CE6: 2-D Index Map Coding of Palette Mode in HEVC SCC,” JCTVC-S0151, Strasbourg, FR, October 2014, and U.S. Provisional Patent Application No. 62/060,450 entitled, “On Improved Palette Mode in HEVC SCC,” filed October 2014, which are incorporated herein by this reference. While not fully described herein for the sake of brevity, those skilled in the art will appreciate that the 2-D string copy methods may default to a run based 1-D string copy method in some circumstances.

When index mode coding in palette mode using the 1-D string method, two main parts are involved for each CU. Those two parts are color table processing and index map coding. By way of example, the index map coding for the 1-D string method may utilize a COPY_ABOVE mode, where COPY_ABOVE is applied to indicate whether the current string is identical to the indices from the string directly above the current string.

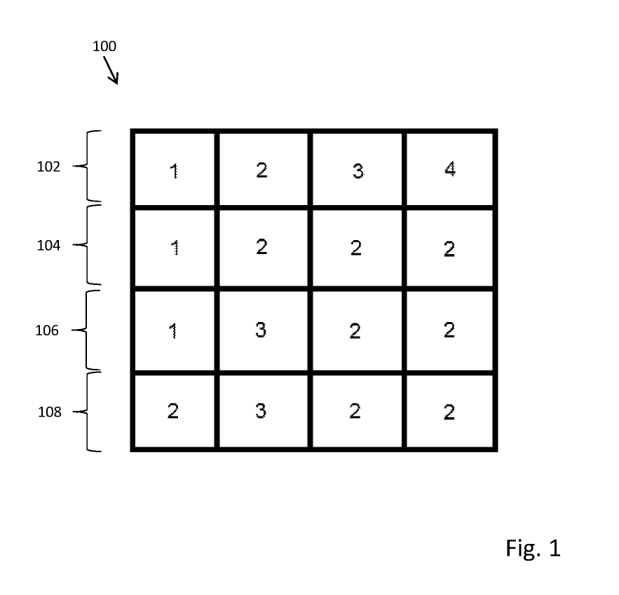

FIG. 1 illustrates a 4×4 block 100 of index map colors that will be used to provide an example of index map coding using COPY_ABOVE in the 1-D string method. As shown, a top string 102 in the block 100 has the index values 1, 2, 3, and 4 (from left to right), the string 104 immediately below the top string 102 has the index values 1, 2, 2, and 2, the next string 106 in the block 100 has the index values 1, 3, 2, and 2, and the bottom string 108 in the block 100 has the index values 2, 3, 2, and 2. To encode the first string 102 in a bitstream, a palette_run_type flag (e.g., a one-bit palette_run_type_flag), an index value, and a run value are used.

The palette_run_type flag indicates whether any index values in the string above the current string have been copied. If a portion of the string above has been copied, the palette_run_type flag is set to a first binary number (e.g., 1) representing the COPY_ABOVE_MODE. If the string above has not been copied, the palette_run_type flag is set to a second binary number (e.g., 0) representing the COPY_INDEX_MODE. When encoding the top string 102, the palette_run_type flag is set to 0 by default because there are no strings disposed above the top string 102. The index value is the particular number value (e.g., 1, 2, 3, or 4) represented within the string in the block 100. The run value is how many consecutive index values may be copied. For example, if the run value is set to 1, a single index value is copied, if the run value is set to 2, two consecutive index values are copied, if the run value is set to 3, three consecutive run values are copied, and so on. So, to encode the top string 102 having the index values 1, 2, 3, 4, the following syntax is used: palette_run_type_flag-0, index value=1, run value=1, palette_run_type_flag=0, index value=2, run value=1, palette_run_type_flag=0, index value=3, run value=1, and palette_run_type_flag=0, index value=4, run value=1.

To encode the next string 104 having index values 1, 2, 2, 2, the following syntax is used: palette_run_type_flag=1, run value=2, palette_run_type_flag=0, index value=2, run value=2. To encode the next string 106 having index values 1, 3, 2, 2, the following syntax is used: palette_run_type_flag=1, run value=1, palette_run_type_flag=0, index value=3, run value=1, and palette_run_type_flag-0, index value=2, run value=2. To encode the bottom string 108 having the index values 2, 3, 2, 2, the following syntax is used: palette_run_type_flag=0, index value=2, run value=1, palette_run_type_flag=1, run value=3.

Currently, the palette_run_type_flag is encoded by context adaptive binary arithmetic coding (CABAC) using a context model with two different contexts (e.g., context A and context B). When deciding the correct context for coding a current palette_run_type_flag, the value of the flag for the string (or row) immediately above the current string is considered. For example, if the value of the palette_run_type_flag for the string immediately above the current string has a value of 1, then the current palette_run_type_flag is coded in the bitstream using context A. If, however, value of the palette_run_type_flag for the string immediately above the current string has a value of 0, then the current palette_run_type flag is coded in the bitstream using context B. If there is no string disposed immediately above the current string, then the palette_run_type_flag is coded in the bitstream using a default context (e.g., context B). Thus, conventional encoding of the palette_run_type_flag relies upon the use of two different contexts depending on the value for the palette_run_type_flag of the string immediately above the current string.

It has been discovered, however, that there is little correlation between the value of the palette_run_type_flag for the current string and the value of the palette_run_type_flag for the string immediately above the current string. Therefore, the predictive context model described above is not necessary when encoding the palette_run_type_flag. To reduce the overall codec complexity, a simplified context model is proposed whereby the palette_run_type_flag for a current string is encoded without referencing the palette_run_type_flag of an adjacent string. Because encoding of the palette_run_type_flag for a current string is performed without regard for the palette_run_type_flag of an adjacent string (e.g., the string immediately above the current string), only a single context is needed for encoding. In other words, the simplified context model proposed herein only needs one context model in order to encode the palette_run_type_flag for a current string. Where the block (e.g., block 100 of FIG. 1) includes multiple strings of index values, the palette_run_type flag corresponding to each individual string may be encoded using a single context without referencing the palette_run_type_flag of neighbor strings. Using the simplified context model offers a variety of benefits including, for example, reducing the total number of contexts for the entire codec and making the encoding and decoding process simpler due to the fact that the run-type from a reference string need not be considered. In addition, the simplified context modeling for palette mode does not introduce any new syntax elements to the coding process. Moreover, use of the simplified context model did not result in a noticeable coding performance change in tests. Thus, the simplified context model simplifies entropy (e.g., lossless) encoding of the palette_run_type_flag.

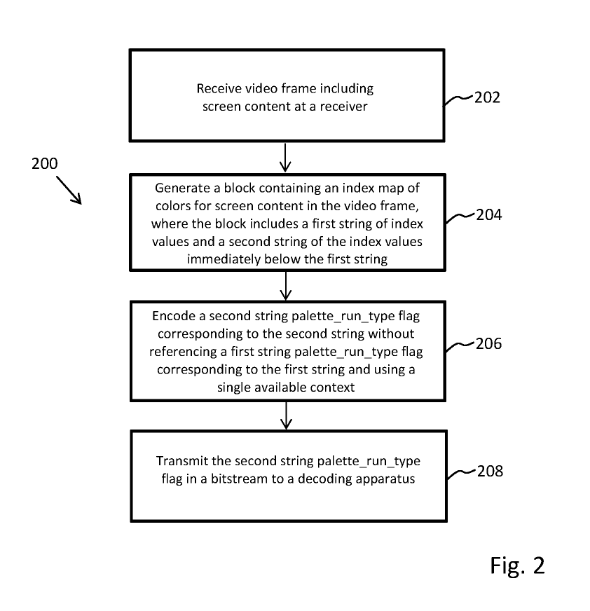

FIG. 2 is a flowchart of an embodiment of a method 200 of coding using the simplified context model. The method 200 may be implemented when, for example, a video frame has been received and a palette_run_type flag needs to be encoded for a bitstream that will be transmitted to a decoding apparatus. In block 202, a video frame including screen content is received at a receiver. The screen content does not include any camera-captured video. Rather, the screen content is non-camera-captured images such as, for example, text, computer graphic content, and the like. In block 204, a block (e.g., block 100 in FIG. 1) containing an index map of colors for screen content in the video frame is generated by a processor. The block includes a first string (e.g., first string 102 in FIG. 1) of index values and a second string (e.g., second string 104 in FIG. 1) of the index values immediately below the first string.

In block 206, a second string palette_run_type flag corresponding to the second string is encoded by a processor without referencing a first string palette_run_type flag corresponding to the first string and using a single available context. In an embodiment, the single available context is based on the CABAC model. In block 208, the second string palette_run_type flag is transmitted in a bitstream to a decoding apparatus. It should be recognized by those skilled in the art upon reviewing this disclosure that subsequent string palette_run_type flags corresponding to subsequent strings may also be encoded without referencing an adjacent string palette_run_type flag corresponding to an adjacent string and using the single available context.

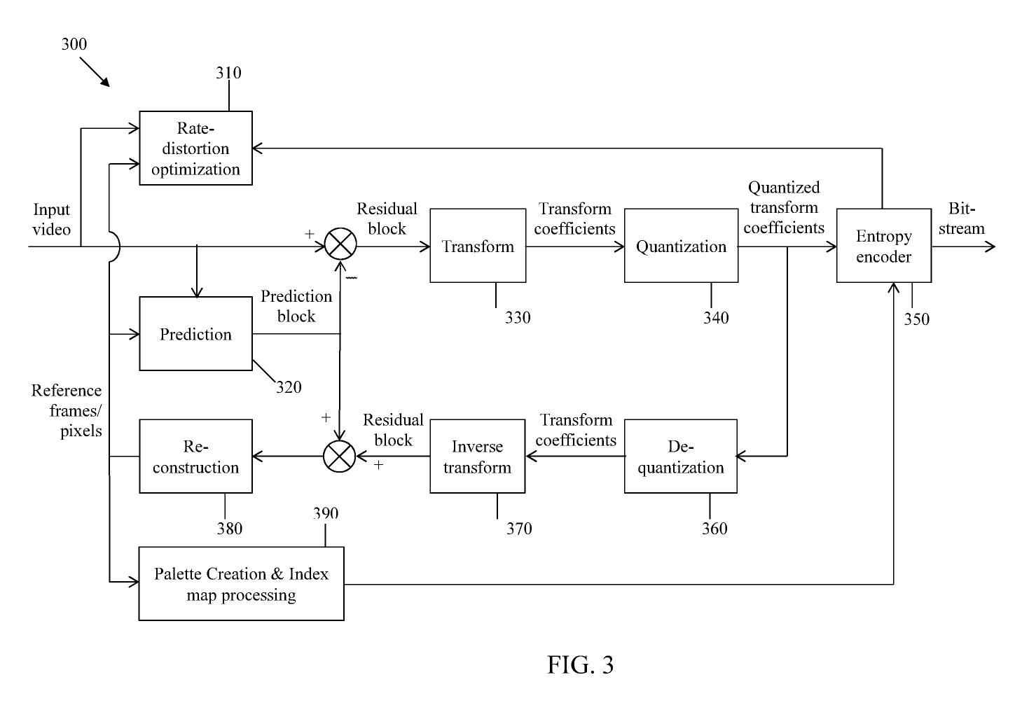

FIG. 3 illustrates an embodiment of a video encoder 300. The video encoder 300 may comprise a rate-distortion optimization (RDO) module 310, a prediction module 320, a transform module 330, a quantization module 340, an entropy encoder 350, a de-quantization module 360, an inverse transform module 370, a reconstruction module 380, and a palette creation and index map processing module 390 arranged as shown in FIG. 3. In operation, the video encoder 300 may receive an input video comprising a sequence of video frames (or slices). Herein, a frame may refer to any of a predicted frame (P-frame), an intra-coded frame (I-frame), or a bi-predictive frame (B-frame). Likewise, a slice may refer to any of a P-slice, an I-slice, or a B-slice.

The RDO module 310 may be configured to coordinate or make logic decisions for one or more of other modules. For example, based on one or more previously encoded frames, the RDO module 310 may determine how a current frame (or slice) being encoded is partitioned into a plurality of CUs, and how a CU is partitioned into one or more PUs and TUs. As noted above, CU, PU, and TU are various types of blocks used in HEVC. In addition, the RDO module 310 may determine how the current frame is to be predicted. The current frame may be predicted via inter and/or intra prediction. For intra prediction, there are a plurality of available prediction modes or directions in HEVC (e.g., 34 modes for the Y component and six modes (including linear mode (LM)) for the U or V component), and an optimal mode may be determined by the RDO module 310. For example, the RDO module 310 may calculate a sum of absolute error (SAE) for each prediction mode, and select a prediction mode that results in the smallest SAE.

In an embodiment, the prediction module 320 is configured to generate a prediction block for a current block from the input video. The prediction module 320 may utilize either reference frames for inter prediction or reference pixels in the current frame for intra prediction. The prediction block comprises a plurality of predicted pixel samples, each of which may be generated based on a plurality of reconstructed luma samples located in a corresponding reconstructed luma block, and a plurality of reconstructed chroma samples located in a corresponding reconstructed chroma block.

Upon generation of the prediction block for the current block, the current block may be subtracted by the prediction block, or vice versa, to generate a residual block. The residual block may be fed into the transform module 330, which may convert residual samples into a matrix of transform coefficients via a two-dimensional (2-D) orthogonal transform, such as a discrete cosine transform (DCT). Then, the matrix of transform coefficients may be quantized by the quantization module 340 before being fed into the entropy encoder 350. The quantization module 340 may alter the scale of the transform coefficients and round them to integers, which may reduce the number of non-zero transform coefficients. As a result, a compression ratio may be increased. In an embodiment, the entropy encoder 350 is configured to implement the inventive concepts disclosed herein.

Quantized transform coefficients may be scanned and encoded by the entropy encoder 350 into an encoded bitstream. Further, to facilitate continuous encoding of blocks, the quantized transform coefficients may also be fed into the de-quantization module 360 to recover the original scale of the transform coefficients. Then, the inverse transform module 370 may perform the inverse of the transform module 330 and generate a noisy version of the original residual block. Then, the lossy residual block may be fed into the reconstruction module 380, which may generate reconstructed samples for intra prediction of future blocks. If desired, filtering may be performed on the reconstructed samples before they are used for intra prediction. In an embodiment, the encoder 300 and/or the palette creation and index map processing module 390 of FIG. 3 are configured to implement the method 200 of FIG. 2.

It should be noted that FIG. 3 may be a simplified illustration of a video encoder, thus it may include only part of modules present in the video encoder. Other modules (e.g., filter, scanner, and transmitter), although not shown in FIG. 3, may also be included to facilitate video encoding as understood by one of skill in the art. In addition, depending on the encoding scheme, some of the modules in the video encoder may be skipped. For example, in lossless encoding of certain video content, no information loss may be allowed, thus the quantization module 340 and the de-quantization module 360 may be skipped. For another example, if the residual block is encoded directly without being converted to transform coefficients, the transform module 330 and the inverse transform module 370 may be skipped. Moreover, prior to transmission from the encoder, the encoded bitstream may be configured to include other information, such as video resolution, frame rate, block partitioning information (sizes, coordinates), prediction modes, etc., so that the encoded sequence of video frames may be properly decoded by a video decoder.

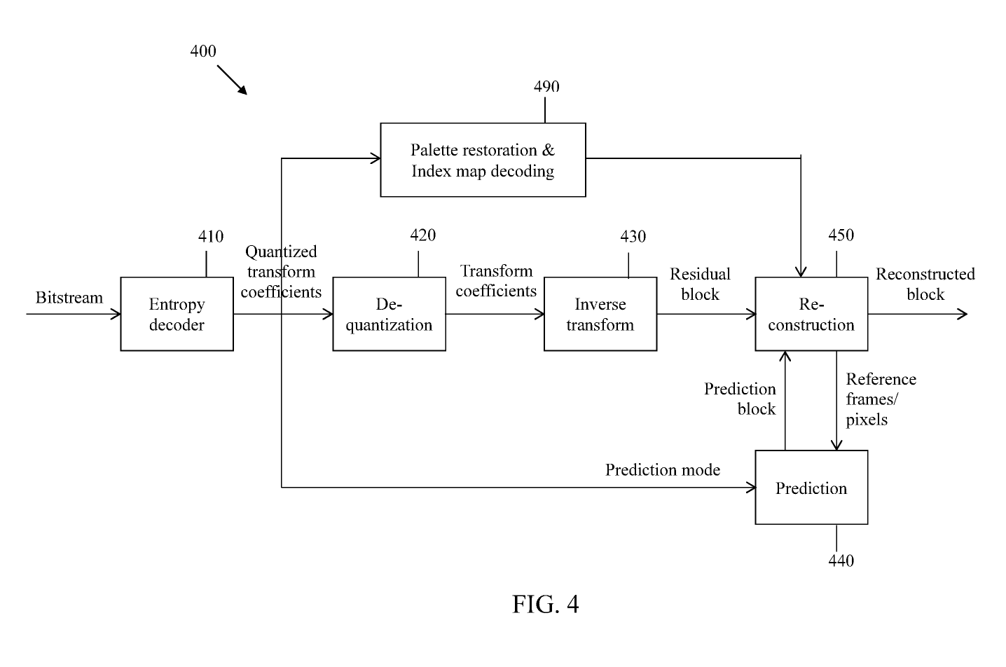

FIG. 4 illustrates an embodiment of a video decoder 400. The video decoder 400 may correspond to the video encoder 300 of FIG. 3, and may comprise an entropy decoder 410, a de-quantization module 420, an inverse transform module 430, a prediction module 440, a reconstruction module 450, and a palette restoration and index map decoding module 490 arranged as shown in FIG. 4. In operation, an encoded bitstream containing information of a sequence of video frames may be received by the entropy decoder 410, which may decode the bitstream to an uncompressed format. A matrix of quantized transform coefficients may be generated, which may then be fed into the de-quantization module 420, which may be the same or similar to the de-quantization module 360 in FIG. 3. Then, output of the de-quantization module 420 may be fed into the inverse transform module 430, which may convert transform coefficients to residual values of a residual block. In addition, information containing a prediction mode of the current block may also be decoded by the entropy decoder 410. The prediction module 440 may generate a prediction block for the current block based on the inventive concepts disclosed herein. In an embodiment, the entropy decoder 410 and/or the palette restoration and index map decoding module 490 are configured to implement the inventive concepts disclosed herein.

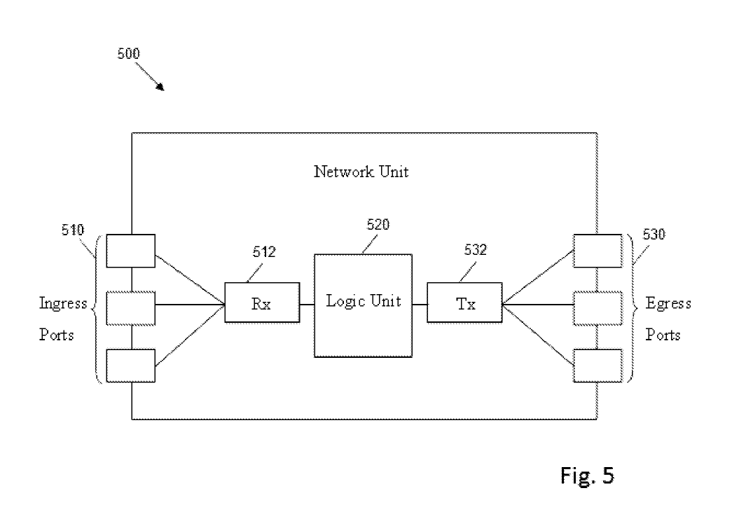

FIG. 5 illustrates an embodiment of a network unit 500, which may comprise an encoder (e.g., encoder 300 of FIG. 3) and decoder (e.g., decoder 400 of FIG. 4) that processes video frames as described above, for example, within a network or system. The network unit 500 may comprise a plurality of ingress ports 510 and/or receiver units (Rx) 512 for receiving data from other network units or components, logic unit or processor 520 to process data and determine which network unit to send the data to, and a plurality of egress ports 530 and/or transmitter units (Tx) 532 for transmitting data to the other network units. The logic unit or processor 520 may be configured to implement any of the schemes described herein, such as encoding without reference to a neighboring string and using a single available context, decoding a palette_run_type flag in a bitstream where the palette_run_type flag encoded without reference to a neighboring string and using the single available context, and/or the method of FIG. 2. The logic unit 520 may be implemented using hardware, software, or both.

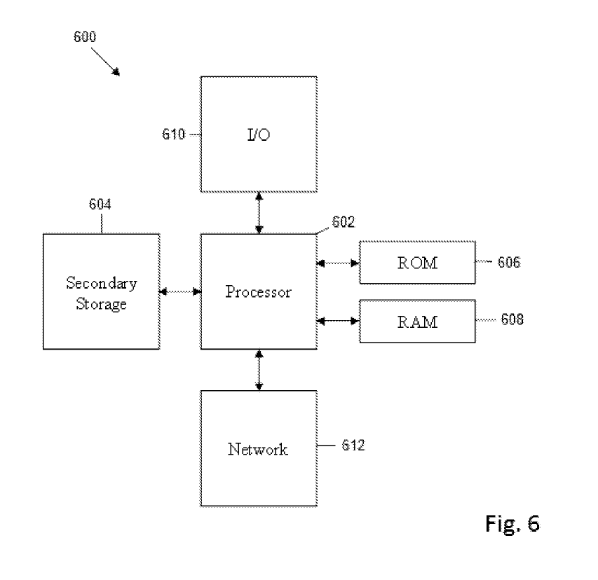

The schemes described above may be implemented on any general-purpose network component, such as a computer or network component with sufficient processing power, memory resources, and network throughput capability to handle the necessary workload placed upon it. FIG. 6 illustrates a schematic diagram of a typical, general-purpose network component or computer system 600 suitable for implementing one or more embodiments of the methods disclosed herein, such as the encoding method 200 of FIG. 2. The general-purpose network component or computer system 600 includes a processor 602 (which may be referred to as a central processor unit or CPU) that is in communication with memory devices including secondary storage 604, read only memory (ROM) 606, random access memory (RAM) 608, input/output (I/O) devices 610, and network connectivity devices 612. Although illustrated as a single processor, the processor 602 is not so limited and may comprise multiple processors. The processor 602 may be implemented as one or more CPU chips, cores (e.g., a multi-core processor), field-programmable gate arrays (FPGAs), application specific integrated circuits (ASICs), and/or digital signal processors (DSPs), and/or may be part of one or more ASICs. The processor 602 may be configured to implement any of the schemes described herein, such as encoding without reference to a neighboring string and using a single available context, decoding a palette_run_type flag in a bitstream where the palette_run_type flag encoded without reference to a neighboring string and using the single available context, and/or the method of FIG. 2. The processor 602 may be implemented using hardware, software, or both.

The secondary storage 604 is typically comprised of one or more disk drives or tape drives and is used for non-volatile storage of data and as an over-flow data storage device if the RAM 608 is not large enough to hold all working data. The secondary storage 604 may be used to store programs that are loaded into the RAM 608 when such programs are selected for execution. The ROM 606 is used to store instructions and perhaps data that are read during program execution. The ROM 606 is a non-volatile memory device that typically has a small memory capacity relative to the larger memory capacity of the secondary storage 604. The RAM 608 is used to store volatile data and perhaps to store instructions. Access to both the ROM 606 and the RAM 608 is typically faster than to the secondary storage 604. One or more of the memory devices disclosed herein (e.g., RAM 608, etc.) may store the software, programming, and/or instructions that, when executed by the logic unit 520 and/or processor 602, implement method 200 of FIG. 2.

The terms network “element,” “node,” “component,” “module,” and/or similar terms may be interchangeably used to generally describe a network device and do not have a particular or special meaning unless otherwise specifically stated and/or claimed within the disclosure.

While several embodiments have been provided in the present disclosure, it may be understood that the disclosed systems and methods might be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted, or not implemented.

In addition, techniques, systems, subsystems, and methods described and illustrated in the various embodiments as discrete or separate may be combined or integrated with other systems, modules, techniques, or methods without departing from the scope of the present disclosure. Other items shown or discussed as coupled or directly coupled or communicating with each other may be indirectly coupled or communicating through some interface, device, or intermediate component whether electrically, mechanically, or otherwise. Other examples of changes, substitutions, and alterations are ascertainable by one skilled in the art and may be made without departing from the spirit and scope disclosed herein.

What is claimed is:

1. An encoding apparatus, comprising:
a processor configured to:
receive a video frame including screen content;
generate a block containing an index map of colors for screen content in the video frame, wherein the block includes a first string of index values and a second string of the index values immediately below the first string;
encode a second string palette_run_type flag corresponding to the second string without referencing a first string palette_run_type flag corresponding to the first string and using a single available context; and
a transmitter operably coupled to the processor and configured to transmit the second string palette_run_type flag in a bitstream to a decoding apparatus.

2. The encoding apparatus of claim 1, wherein the block includes a third string immediately below the second string, and wherein the processor is configured to encode a third string palette_run_type flag corresponding to the third string without referencing the second string palette_run_type flag corresponding to the second string and using the single available context.

3. The encoding apparatus of claim 1, wherein the second string palette_run_type flag is a palette_run_type flag.

4. The encoding apparatus of claim 1, wherein the screen content is one of text and computer graphic content.

5. The encoding apparatus of claim 1, wherein the screen content does not include any camera-captured video.

6. The encoding apparatus of claim 1, wherein the first string of index values is a top string within the block.

7. The encoding apparatus of claim 1, wherein each of the index values in the first string and the second string are numerical representations of color.

8. The encoding apparatus of claim 1, wherein the processor is configured to encode the second string palette_run_type flag based on a lossless encoding format.

9. The encoding apparatus of claim 1, wherein the single available context is based on a context adaptive binary arithmetic coding (CABAC) model.

10. The encoding apparatus of claim 1, wherein the decoding apparatus is configured to decode the first string palette_run_type flag encoded using the single available context.

11. A method of encoding, comprising:
receiving, by a receiver, a video frame including screen content;
generating, by a processor operably coupled to the receiver, a block containing an index map of colors for screen content in the video frame, wherein the block includes a first string of index values and a second string of the index values immediately below the first string;
encoding, by the processor, a second string palette_run_type flag corresponding to the second string without referencing a first string palette_run_type flag corresponding to the first string and using a single available context; and
transmitting, by a transmitter operably coupled to the processor, the second string palette_run_type flag in a bitstream to a decoding apparatus.

12. The method of claim 11, wherein the block includes a third string of the index values immediately below the second string of the index values, and wherein the method further comprises encoding a third string palette_run_type flag corresponding to the third string without referencing the second string palette_run_type flag corresponding to the second string and using the single available context.

13. The method of claim 12, wherein the first string palette_run_type flag, the second string palette_run_type flag, and the third string palette_run_type flag are each a palette_run_type flag.

14. The method of claim 11, wherein the screen content is one of text and computer graphic content.

15. The method of claim 11, wherein the screen content consists of non-camera-captured images.

16. The method of claim 11, wherein the screen content does not include any camera-captured video, each of the index values in the first string and the second string are numerical representations of color, and the first string palette_run_type flag and the second string palette_run_type flag are each encoded based on a lossless encoding format.

17. The method of claim 11, wherein the single available context is based on a context adaptive binary arithmetic coding (CABAC) model.

18. A decoding apparatus, comprising:
a receiver configured to receive a second palette_run_type flag in a bitstream, wherein the second palette_run_type flag was encoded without referencing a first string palette_run_type flag corresponding to the first string and using a single available context; and
a processor operably coupled to the receiver and configured to decode the second palette_run_type flag in the bitstream using the single available context.

19. The decoding apparatus of claim 18, wherein the second palette_run_type flag is a palette_run_type flag.

20. The decoding apparatus of claim 18, wherein the second palette_run_type flag corresponds to screen content, wherein the screen content is one of text and computer graphic content and does not include any camera-captured video, and wherein the single available context is based on a context adaptive binary arithmetic coding (CABAC).
